(19) United States
(12) Patent Application Publication
(10) Pub. No.: US 2007/0185757 A1
(43) Pub. Date: Aug. 9, 2007

(54) Talent relationship management with E-recruiting

(75) Inventor: Ganapathy Subramanian, Chennai (IN)

Correspondence Address: KENYON & KENYON LLP, 1500 K STREET N.W., WASHINGTON, DC, 20005, US

(73) Assignee: SAP

(21) Appl. No.: 11/350,642

(22) Filed: Feb. 9, 2006

(51) Int. Cl. G07G 1/00

(52) U.S. Cl. 705/10

(57) ABSTRACT

A method for performing Talent Relationship Management (TRM) of candidates uses target groups formed for specified purposes from candidates constituting a talent pool. The target groups may be formed by a recruiter based on candidate attributes obtained from questionnaires, surveys and from data base information, and may be used for identifying candidates for filling a vacancy in an organization, based on specific requirements of the organization. The candidate attributes may include education, skill level, work specialty, experience, geographical location, and candidate aptitude. Each target group may be nurtured or otherwise managed by offering specialized services to the candidates of the target who share common interests/background. A UI can be used by the recruiter, or an administrator in the case of an organization to view the candidate attributes, candidate listing and other information pertaining to a target group. Only those who are authorized may view and administer/alter the target group listings.

### FIELD OF THE INVENTION

This invention generally relates to organized talent relation management and interaction with member candidates from a talent pool, and more particularly to a method of identifying potentially suitable candidates based on stored and organized information sources for filling a vacancy in an organization.

### BACKGROUND OF THE INVENTION

It is very common in the present day to maintain databases comprising information gathered from surveys and obtained otherwise, regarding individuals including their attributes such as mailing address, age, gender, ethnicity, annual income, automobile/s owned, and interest in electronics and the like. More often than not, such database information is utilized for soliciting business and promoting products. It is also known for organizations to maintain databases and talent pools containing information from qualified individuals including their academic background and vocation that could be used for information or reference. It would be desirable to store and organize the information in the talent pools for application to specific needs and for specific purposes.

In today's recruiting business, it is imperative to maintain the interest of the candidates towards a company's job offers. On the one hand there is a dearth of talent. On the other hand it is becoming increasingly difficult to identify candidates with appropriate talents to fill a vacancy in the company/organization in a timely manner. Research indicates that some of the talented individuals are passive seekers unless they are approached. It is also to be noted that attracting talented individuals and more importantly retaining them in an organization/company is very important. To this end, each company needs to have an organized and comprehensive approach and strategy for talent management and for filling vacancies with the most qualified candidates.

### SUMMARY OF THE INVENTION

This invention uses the concept of target groups in Talent Relationship Management (TRM). To effectively administer these TRM activities, it is desirable to work with smaller groups within the talent pool so that certain TRM activities are administered in an effective and tailor made manner for the target group in question. This necessitates a strategy wherein the entire talent pool is segmented in an effective and efficient way based on the market situation and the current requirements/initiatives of the company. Such strategy would also help the company in identifying the top individuals in the talent pool. These segments can then translate into different target groups for specialized handling/treatment. Segmenting the talent pool into target groups is one part of TRM. The invention also envisages other specialized talent services to be provided for the candidates of a specific target group in the talent pool.

The target group approach as taught herein basically segments candidates in the talent warehouse of a company or in the talent pool into distinct target groups based on specified purposes. From one perspective, a target group forms a coherent group of candidates on which specific actions can be performed. An administrator or staffing analyst defines what kinds of target groups are to be addressed for a specific interaction. For instance, a company might be interested in all high potentials. Accordingly, a target group called “high potentials” is created and addressed when needed. Expediently, certain recruiters are designated as responsible people for each target group. The recruiters nurture or bring up/develop or otherwise promote each target group. The recruiters might search in the talent pool for suitable candidates and assign the candidates to one or more target groups. The recruiters might send specialized correspondence/questionnaires to the candidates belonging to a specific target group in the talent pool. Some examples of target groups in a talent pool could be: high potentials, alumni, and fresh graduates, to name a few. The concept of segmenting and target grouping is useful also in marketing or in the CRM (customer Relations Management) area. However, this invention teaches the application of the target group approach for doing TRM, particularly in the SAP HR E-recruiting area.

The target group concept is applied as taught herein in one embodiment, to maintain a relationship with the candidates in the talent pool. Since each target group in the talent pool is intended to be nurtured in the present approach, it is easier, when a vacancy arises, for the administrator to identify a specific target group from which to select a suitable candidate. When the candidate is approached, it facilitates the candidate retaining the interest in the company.

One embodiment of the invention teaches a method of maintaining talent relationship with candidates from a talent pool, comprising the steps of: consolidating a talent pool of candidates and obtaining candidate attributes from sources selectively including database/s and questionnaires sent to the candidates; based on said candidate attributes, performing candidate classification using predetermined requirements; from said candidate classification, forming, storing and maintaining target groups of candidates using specified purposes; and using the target groups for nurturing/developing candidates' interest in selected target groups.

A second embodiment teaches a method of identifying a potentially suitable candidate from a talent pool to fill a vacancy in an organization, comprising the steps of: consolidating a talent pool of candidates and obtaining candidate attributes from sources selectively including database/s and questionnaires sent to said candidates; based on said candidate attributes, performing candidate classification using predetermined requirements; from said candidate classification, forming, storing and maintaining target groups of candidates using specified purposes; using a selected target group to identify possible candidates to fill a vacant position in the organization as desired.

The candidate attributes might include education, skill level, specialty, experience, candidate's geographical location, candidate's aptitudes and interests. The specified purpose governing formation of the target groups might comprise suitability of candidates for managerial jobs, and similarity of goals of the candidates, for example. Nurturing might include offering candidates and opportunity for added education/training, and exposure to new areas of expertise, for instance. The method taught herein might include the steps of tracking as to when a specific candidate was listed in a particular target group, and tracking the candidate's employment and experience history.

Another embodiment teaches a method of identifying a suitable candidate to fill a vacancy in an organization, using a target candidate group from a talent pool of potential candidates, comprising the steps of: using a UI (user interface) connected to a database and selectively to other information, to obtain notification of a position/vacancy; generating a requisition to fill the vacancy; initiating a candidate search in a selected target candidate group; completing an interaction among a UI user, a business partner/manager and a central coordinating person to obtain an output and feed to a relevant target group; initiate an application from a chosen potential candidate to fill the vacancy; and, authorizing posting of the candidate to fill the vacancy.

The invention includes articles comprising a storage medium having instructions thereon which when executed by a computing platform will result in execution of one or the other of the methods recited above. Modifications and variations in the manner of implementing the different method steps are conceivable and are envisaged to be within the ambit of this invention.

### BRIEF DESCRIPTION OF THE DRAWING

A more detailed understanding of the invention may be had from the following detailed description, given by way of example and to be understood in conjunction with the accompanying drawing wherein:

FIG. 1 illustrates an exemplary flow chart for using the target group approach to assist in filling a vacant position in an organization

FIG. 2 illustrates an exemplary talent relationship management flow chart in accordance with one embodiment;

FIG. 3 shows a chart of how a vacancy in an organization may be filled by implementing the target group concept; and,

FIG. 4 illustrates a general purpose computing platform which may be used in implementing the method by the invention.

### DETAILED DESCRIPTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims.

A target group as understood herein is a segment of the Talent Pool that is distinguished for at least one specific purpose. One such purpose comprises TRM, and, for purposes of TRM, a target group thus forms a coherent group of candidates on which specific actions can be performed, such as for example:
To send specific questionnaires to all High Potential candidates.
To send a reminder to all candidates who have not logged on for the last 6 months etc.

In one embodiment, the question whether a candidate belongs to a specific target group is determined on the basis of a segmentation principle and would not be known to the candidate in the group.

Who can define target groups?

Expediently, there would be an administrator or a super recruiter who will define target groups that are of interest to the company. These target groups however may not be defined on a day-to-day basis.

The definition of target groups requires effort from the side of the administrator. The administrator may have a dedicated UI to define/update/view the target groups. Some of the attributes that can act as criteria to define target groups, (as three examples,) could be:
Education Type
   University
Education Level
   Doctorate
Experience
   Over 20 years
      The above three target groups may be integrated to form another target group known as Experienced Professionals. One can define a target group for Top Performers and earmark potential candidates for an important position inside the company.

Furthermore, the Administrator may also be empowered to define who the recruiters are and who would be authorized to view candidates from a specific target group, based on the knowledge that the recruiter knows that a candidate belongs to the specific target group. An additional authorization to a recruiter could be the duty to assign candidates to the specific target group. The recruiter can be envisaged as an owner of a specific target group. This arrangement is conducive to Talent Relationship Management with regard to Career and Succession Planning. However one or more recruiters would have the authorization to view the group and the fact that a particular candidate belongs to that target group. The recruiter who does not have the authorization to view a particular target group will not see that target group and, although he can find a candidate belonging to this target group, he will not be able to see the target group assignment.

Further application of target groups Broadly it is beneficial for an organization that is a customer who buys or uses the present methodology, to address specific requirements and provide tailor made services to different target groups of candidates in a large talent pool. Specific purposes may be accomplished be addressing selected target groups differently. Some of the different purposes envisaged with target groups include:
Legal requirement-conformity; User friendliness; Safeguarding skill availability; Career planning; Talent Pool clean up; and, Brand Reinforcement.

Customers can use these target groups for more than the purposes listed above. Expediently, certain areas in the application that would influence the construction of the target groups have been identified as comprising the following:

Questionnaires
a. There could be certain questionnaires that are sent for a specific target group.
b. It could be a survey or a feedback
c. It could be evaluated or just used for reporting
d. It would be achieved though an existing Activity Management framework
   Data Overviews:
e. This is a direct implication that recruiters cannot see Questionnaires target groups in data overviews of candidates.
   Candidate User Interface; and, Search/Hit Lists:

It is beneficial for a corporate recruiter to understand the company's staffing needs and how the candidate population segments into distinct groups. This is one idea behind segmenting the Talent Pool into different target groups.

In one approach, a target group is defined as a group of candidates with similar attributes/properties and it is up to the customer to offer those candidates specific services. A target group is seen as the result of the current company recruiting strategy, whereby the lifetime of those groups is not for eternity. The assignment of a candidate to a target group is not necessarily a qualitative judgement on the candidate.

In a second approach, a target group would be a very generic tool for the purpose of segmenting the candidates into different groups for specific purposes. Customers can create any kind of target groups based on their needs. However it should be noted that there may be no preexisting unique process support for these target groups. Different companies might pick up the concept of target groups in different ways. What are the “targets” of these companies? To get a feeling for customer-needs, some examples of target groups are discussed herein, noting that the examples are simplified for the sake of clarity. These examples simply show what kind of target groups can be created, what purpose they can serve and also highlight the fact that the process for creating the target groups can be tailored to suit the requirements of the organization.

E-Recruiting:

Candidates that show interest or are relevant for specific functions (Management, Financials, IT, etc.) or candidates belonging to different professional/experience levels (graduates, professionals with n years of experience) are grouped together in corresponding target groups. This allows recruiters to “collect” interesting candidates in dedicated target groups and to run activities on those candidates. As an example, candidates that report professional experience in a management position within a company are of special interest for the company. Recruiters search for such candidates on a regular basis and add them to a specific target group. During the recruiting process for a dedicated job, these candidates are preferably taken into consideration.

Talent Management: One purpose of talent management is to ensure that there are enough qualified candidates available for key positions in the enterprise. To implement this, companies set up a process around identifying talented candidates. This process varies depending on the kind of talent. For talented candidates that have the potential to take a management career, senior managers up to the board level are involved. For example, during the quarterly talent review meeting with board members and selected line managers, certain employees are identified for a management career. The responsible recruiter takes the names with him and adds them to the target group “Management Candidates” in the e-recruiting system. For the next vacancy in the management area, the recruiter is asked to deliver a list of potential candidates. He restricts the search in the talent pool to the target group “Management Candidates” and creates a preliminary list of candidates based on the target group “Management candidates”.

Talent pool segmentation herein is viewed as an option for the Recruiter/Succession—Planner to assign a candidate to one or more target groups. The target groups that may be of relevance for certain needs may be static target groups. This means that these target groups will not be derived for candidates dynamically. Candidates will need to be assigned to a target group via a process involving at least partially manual action performed by an acting person and not an automatic assignment. Preferably, the manual action should be such that it can be performed by anyone as a single step and through mass processing. Furthermore, the target groups can be maintained via an expert web application, so that they can by created, changed and deleted depending on the needs of the recruiting strategy. Each target group preferably has an “owner”, who has the authorization to control all administrative aspects of the target group. In certain applications, target groups are only planned for the candidates and not for their applications. To assign and reassign a candidate to a target group or view the assignment, it requires the recruiter to have a corresponding authorization. Target groups can be used to search in the talent pool and address the corresponding candidates via various TRM activities.

From another angle, target groups could be a basis for Succession Planning, so that the expert in charge can assign identified employees to a corresponding target group.

A target group would be a very generic tool for the purpose of segmenting the candidates into different groups, and, customers can create any kind of target groups based on their needs. However it should be noted that there is no unique process support for these target groups. Different companies might pick up the concept of target groups in different ways. What are the “targets” of these companies? To get a feeling for customer-needs some examples of target groups are discussed, noting that the examples are simplified for the sake of clarity. These examples simply show what kind of target groups can be created, what purpose they can serve and also highlight the fact that the process for creating the target groups can be tailored to suit the requirements of the organization.

In one implementation, talent pool segmentation herein is viewed as an option for the Recruiter/Succession-Planner to assign a candidate to one or more target groups. The target groups that may be of relevance for certain needs may be static target groups. This means that these target groups will not be derived for candidates dynamically. Candidates will need to be assigned to a target group via a process involving at least partially manual action performed by an acting person and not an automatic assignment. Preferably, the manual action should be such that it can be performed by anyone as a single step and through mass processing. Furthermore, the target groups can be maintained via an expert web application, so that they can by created, changed and deleted depending on the needs of the recruiting strategy. Each target group preferably has an “owner”, who has the authorization to control all administrative aspects of the target group. In certain applications, target groups are only planned for the candidates and not for their applications. To assign and reassign a candidate to a target group or view the assignment, it requires the recruiter to have a corresponding authorization. Target groups can be used to search in the talent pool and address the corresponding candidates via various TRM activities.

From another angle, target groups could be a basis for Succession Planning, so that the expert in charge can assign identified employees to a corresponding target group.

An important question is how target groups can be used in E-Recruiting by the recruiters in order to interact more effectively with the candidates. The following in a broad view of such process: Activities and Processes can be based on the Target groups the recruiter is dealing with.
a. For instance a specific activity of sending correspondence can be done for all the “Senior Management candidates or High Potentials” within the company inviting them for a meeting with the CEO if applicable.
b. A special questionnaire can be sent to a target group “ex-employees” asking about certain feedback of the Talent Pool.
c. A special invitation can be sent inviting members of certain target groups for a Job Fair of the company, the target groups being “Top Candidates” as well as “Experienced Professionals” and all “Graduates”. A recruiter can attach one or more target groups to a requisition. In that sense it can be an attribute of the requisition itself. This can help the recruiter during the applicant-tracking process for sourcing candidates who belong to those target groups. This could also be directly used in Succession Planning to have the “High Potentials” target group assigned to a “Key Position” requisition.

The target groups would be displayed in the data overviews of the candidates. Only the authorized support team members of the corresponding target group can see the assignment. Also, the display would be visible for the recruiter only if the recruiter is authorized to view the target group. The recruiter can search for candidates belonging to different target groups based on the authorization they have for accessing the target groups. The target groups can also be shown in the hit lists of Candidate Overview/TRM search.

Attributes of Target Groups:

Certain Administrative Data Needs to be Stored about the Target Groups. This Could Include:

Target group ID;
Target group name; and,
Target group Description:
a. This could be important since the person creating the target group can outline the broad parameters and requirements and the need for such a target group.
b. This would include a detailed description, for example, of what the purpose of this target group is and would also contain administrative details about this target group. For example, the description could cover details as to which country or company this target group should cater to, in addition to describing other details.
c. Both the target group name and target group description need to have a language key. The language key facilitates the translation of these texts for later releases. For example, the language key could correspond to English or German, or any other language required by a customer.
Target group creation Date
Target group: Person or Owner/Responsible

This is the person who actually is responsible for the target group. This field is filled with the creator of the target group, but can be changed as necessary. The name of the person responsible is included. He may also be one of the target group support team members. The name of the person responsible may be used for information purposes only.

Target Group Support Team Members and Responsible Persons:

Assignment of owners/responsible persons for a target groups: There would be a set (one or more) recruiters who are responsible for a target group. It is up to these recruiters to fill/populate the target groups with appropriate candidates from the Talent Pool. They would also be responsible for administering various activities on this target group. Also, certain Support Team Members for the target groups are assigned. The Person Responsible is automatically assigned as a Support Team Member. A set (one or more) of recruiters or Succession Planners can be assigned in addition. During the later process, only the Support Team Members of a target group can add appropriate candidates from the Talent Pool to the target group.

Further Support Team Members can be added to a target group by every other Support Team Member (same concept for Support Team Members as already existing throughout e-recruiting)

Support Team Members can be deleted from the support team by any authorized support team member.

Other Attributes of Target Groups:

Attachments can be uploaded as an additional attribute of a target group. The attachments can contain some documents regarding the need and purpose for such a target group. The basic idea here could be to reuse an existing Requisition Attribute infotype also to store the other attributes of a target group. This could assist in the future to extend the scope of target groups in terms of attributes. For instance at a later point it might be desirable to bring in qualifications as well as education as attributes of a target group. These other attributes can be displayed on the User Interface as necessary.

Differentiating features of various target groups may be based on the following characteristics:
1. Purpose
2. Segmentation principle
3. Different services/service levels
4. Different web entry points
5. Different Look and feel (style sheets)
6. Different user interfaces (e.g., menu structure)
7. Different applicant tracking processes
8. Specific questionnaires
9. Specific posting channels
10. Short or long lived
11. Searchable (recruiter authorizations/visibility-owner versus other recruiters)
12. Assignment (can the candidate determine his target group, is it the recruiter or is it an automatic process?)
13. Is the assignment visible for the candidate?

The following considerations shed light on the implementation of the target group approach in the present invention. The considerations are in a form wherein each question is followed by a possible answer:
1. Can a candidate be in more than one target group? . . . Yes
2. Can target groups overlap? . . . Yes
3. Can target groups include other target groups? . . . Yes
4. Are target groups visible by the candidate? . . . This depends on the type of target group.
5. Can a recruiter search on target groups (is it part of his search screen)? . . . Again, this depends on the type of target group.
6. Can a recruiter search through all target group assignments? . . . This depends on the type of target group. It may be that certain target groups have a secretive character (e.g., high potentials). Not all recruiters will then be allowed to see it.
7. Should talent pool access rights be set at target group level? . . . Preferably, this is true especially for outsourcing parts of the recruitment functions.
8. Can a talent pool be segmented for different purposes at one time? For instance, is it feasible to create a geographical division but also a function level division at one time? . . . Yes, this then becomes a multidimensional structure.
9. Is a target group assignment automatically derived? If so, can a target group assignment be overruled by a recruiter? . . . Yes. Is a history kept? . . . It can be.
10. What is the relation between target groups and questionnaires? . . . Some questionnaires may be specific for a target group (e.g., alumni: “do you want to receive the Old boys' journal?”).
11. What is the relation between target group and requisitions? . . . A target group is in between the talent pool and the requisition. A requisition may be relevant for different target groups.
12. Is a target group stored as an attribute with requisitions? If not, how does this affect performance? . . . This can be decided by the customer requirements.
13. Is a target group stored as an attribute of a candidate? If not, how does this affect performance? . . . this can be decided by customer requirements.
14. Who can define and remove target groups? . . . A “super recruiter” can do this. That is, a recruiter with sufficient authorization, but not a normal recruiter.
15. Is there something like a service level, which is different from a target group? . . . A system can be implemented wherein a service level (set of services offered to candidates) may be changed on the basis of a target group.
   There may be other requirements which can be addressed, designed/tailored and implemented, based on customer requirements.

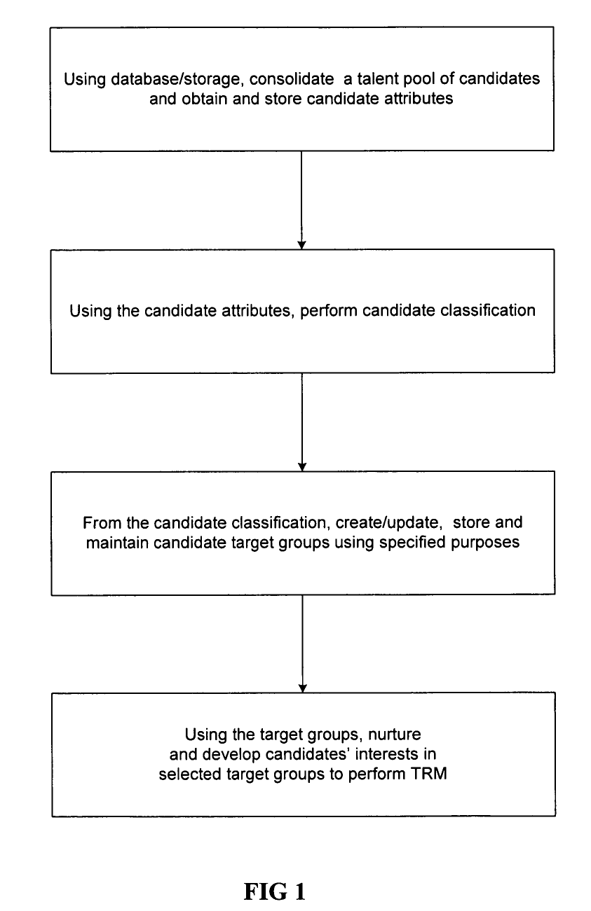

With specific reference to the FIGS, FIG. 1 illustrates a flow diagram of the steps which can be followed in implementing TRM as taught herein. The steps in FIG. 1 relate to method of maintaining talent relationship with candidates from a talent pool, and comprises the steps of: consolidating a talent pool of candidates and obtaining candidate attributes from sources selectively including database/s and questionnaires sent to said candidates; based on said candidate attributes, performing candidate classification using predetermined requirements; from said candidate classification, forming, storing and maintaining target groups of candidates using specified purposes; and, using said target groups to nurture/develop candidates' interest in selected target groups.

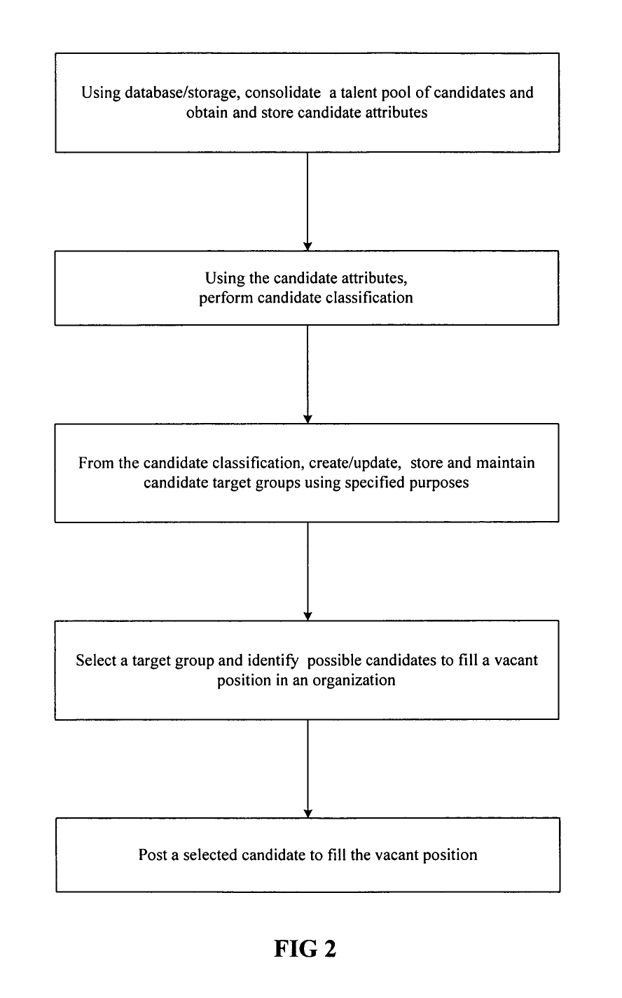

FIG. 2 illustrates a method of filling a vacancy in an organization, by identifying a potentially suitable candidate from a target group of a talent pool to fill the vacancy, and includes the steps of: consolidating a talent pool of candidates and obtaining candidate attributes from sources selectively including database/s and questionnaires sent to said candidates; based on said candidate attributes, performing candidate classification using predetermined requirements; from said candidate classification, forming, storing and maintaining target groups of candidates using specified purposes; using a selected target group to identify possible candidates to fill a vacant position in the organization as desired. The steps in FIGS. 1 and 2 as described above may be modified to and tailored based on customer requirements, without departing from the scope of the invention.

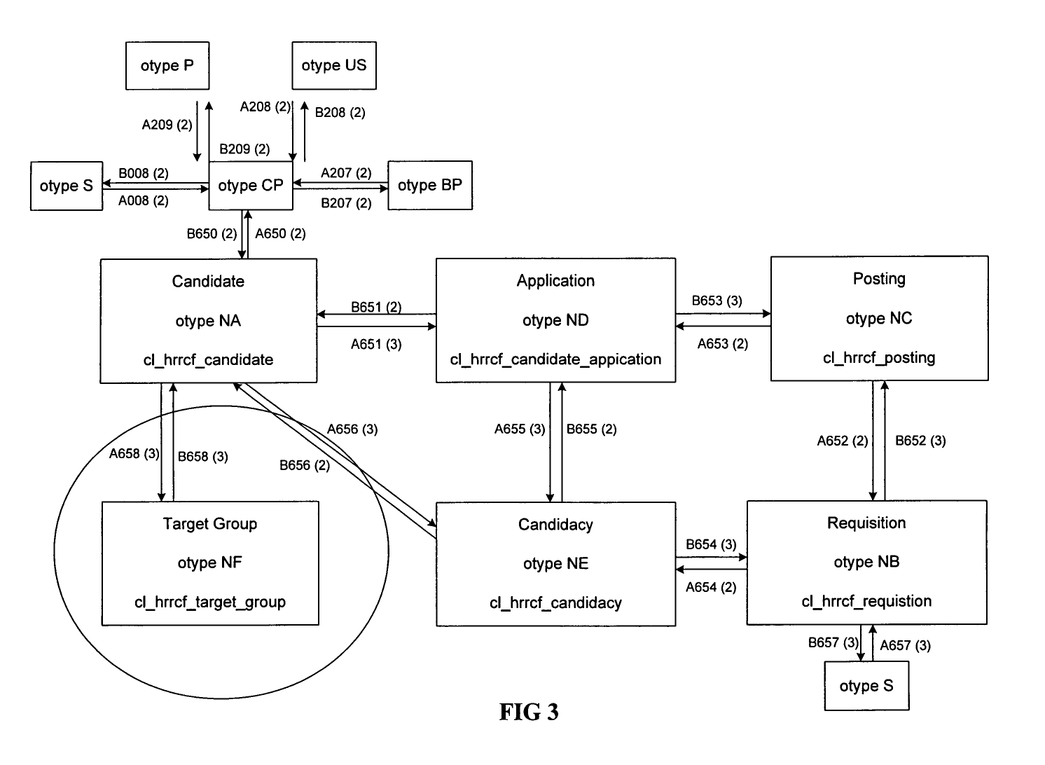

FIG. 3 is a Data model Power Point illustration of how the target group approach can be implemented in filling a vacancy in an organization after considering the availability of a position/vacancy, inputs from the concerned business manager and the HR and the information from a selected target group. The illustration in FIG. 3 may be understood in light of the following explanation of notations in Data model Power Point of FIG. 3:
P—Person
CP—Central Person
US—User
BP—Business Partner
S—Position
NA—Candidate
NB—Requisition
NC—Posting
ND—Application
NE—Candidacy (Candidature)
NF—Target group
   These are all Object Types or Business Objects within the SAP system. The acronyms shown in FIG. 3 are chosen to accommodate namespace restrictions. Their semantic meanings in the business world are given herein.

In the FIG. 3 illustration, the arrows or lines running from one object to the other relate to the relationship between these objects in the real world. These are explained below:
A208—Is identical to.
A209—Is filled by.
A207—Is identical to.
A008—Holder.
A650—Is candidate for.
A651—Has application.
A653—Applies for.
A654—Is candidacy for.
A655—Has candidacy.
A652—Posts.
A656—Has candidacy.
A657—is occupied by means of.

All the B*** relationships are just the inverse of the A*** relationship in meaning.

The numbers within the parenthesis indicate the cardinality of the relationship. This is for technical representation and not relevant on a higher level.

Within the boxes for some of the Objects, the class names (like CL_HRRCF_CANDIDATE) are indicated. These classes are the core classes which contain the behavior of these Objects on a technical level.

The FIG. 3 illustration is given as an example of a DATA MODEL to suit requirements of an individual customer, yet retaining and using the target groups formed from a talent pool.

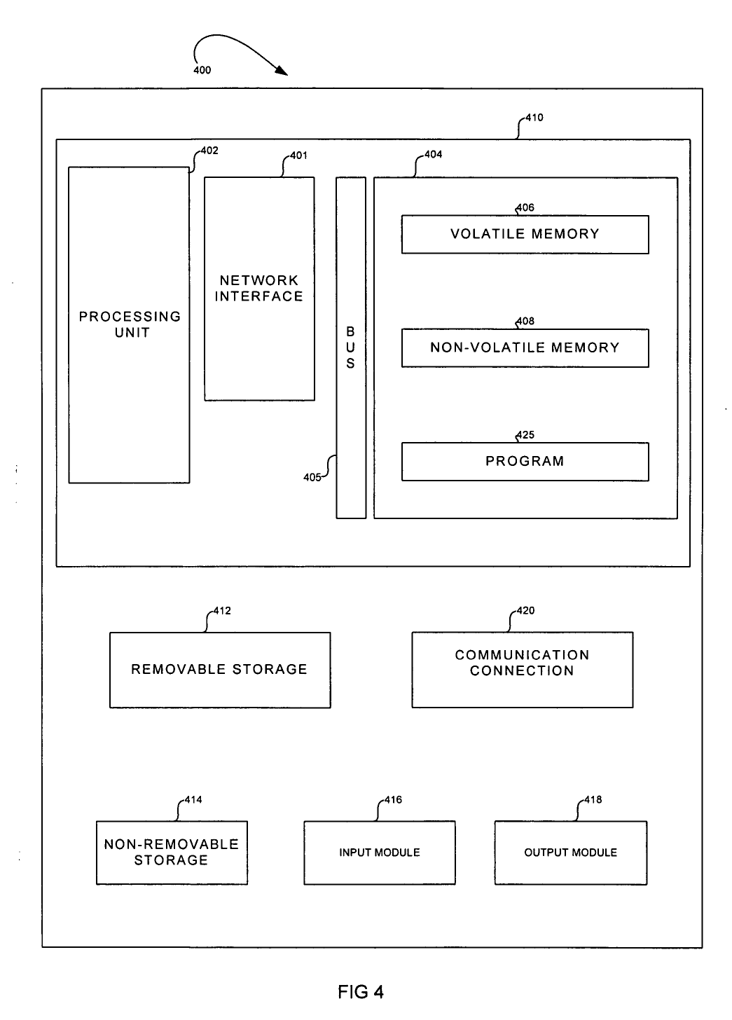

Various embodiments of the present subject matter can be implemented in software, which may be run in the environment shown in FIG. 4 or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs of all types)), laptop devices, multi-processors, microprocessors, set-top boxes, programmable consumer electronics, network computers, minicomputers, mainframe computers, distributed computing environments and the like to execute code stored on a computer-readable medium. It is also noted that the embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 4 shows an example of a suitable computing system environment for implementing embodiments of the present subject matter. FIG. 4 and the following discussion are intended to provide a brief general description of a suitable computing environment in which talent relationship management and related inventive concepts contained herein including filling a vacancy from a talent pool, may be implemented.

With further reference to FIG. 4, a general computing device in the form of a computer 410 may include a processing unit 402, memory 404, removable storage 412, and non-removable storage 414. Computer 410 additionally includes a bus 405 and a network interface (NI) 401. Computer 410 may include or have access to a computing environment that includes one or more user input devices 416, one or more output modules or devices 418, and one or more communication connections 420 such as a network interface card or a USB connection. The one or more user input devices 416 can be a touch screen and a stylus and the like. The one or more output devices 418 can be a display device of computer, computer monitor, TV screen, plasma display, LCD display, display on a touch screen, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 412 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts. Machine-readable instructions stored on any of the above-mentioned storage media are executable by the processing unit 402 of the computer 410. For example, a computer program 425 may include machine-readable instructions capable of executing the steps illustrated in FIGS. 1 and 2 selectively, to assist creating/updating a talent pool, and implementing talent relation management. Another version of the program 425 might comprise methodology to assist in filling a vacancy in an enterprise using information from the talent pool and selected target group/s. In one embodiment, the computer program 425 may be included on a CD-ROM and loaded from the CD-ROM to a hard drive in non-volatile memory 408. The machine-readable instructions cause the computer 410 to decode according to the various embodiments of the present subject matter.

The creation/updating of the talent pools and the formation of the target groups and their use either for the purpose of TRM or for filling a vacancy in an organization may be done using variations in the approach taught in the embodiments above, so long as the crux of the invention is not departed from. Many other embodiments within the ambit of the invention will be apparent to those skilled in the art upon reviewing the above description. The scope of the subject matter of the present invention should therefore be determined with reference to the following claims, along with the full scope of equivalents to which such claims are entitled.

1. A method of maintaining talent relationship with candidates from a talent pool, comprising the steps of:
consolidating a talent pool of candidates and obtaining candidate attributes from sources selectively including database/s and questionnaires sent to said candidates;
based on said candidate attributes, performing candidate classification using predetermined requirements;
from said candidate classification, forming, storing and maintaining target groups of candidates using specified purposes;
using said target groups to nurture/develop candidates' interest in selected target groups.

2. A method of automatically identifying a potentially suitable candidate from a talent pool to fill a vacancy in an organization, comprising the steps of:
consolidating a talent pool of candidates and obtaining candidate attributes from sources selectively including database/s and questionnaires sent to said candidates;
based on said candidate attributes, performing candidate classification using predetermined requirements;
from said candidate classification, forming, storing and maintaining target groups of candidates using specified purposes;
using a selected target group to identify possible candidates to fill a vacant position in the organization as desired.

3. The method as in claim 2, wherein the consolidated talent pool comprises candidates from within the organization as well as outside the organization.

4. The method as in claim 1, wherein the consolidated talent pool comprises candidates at large who meet specified requirements, the method including the step of accession of new eligible candidates continually.

5. The method as in claim 1, including the step of designating a responsible person/recruiter for each of said target groups.

6. The method as in claim 1, including the step of automatically selecting possible candidates for vacancies in an organization from a selected target group, considering requirements and preferences of the organization.

7. The method as in claim 1, wherein said candidate attributes include: education, skill level and specialty, experience, geographical location of candidate, candidate's aptitude and interests.

8. The method as in claim 1, wherein for the step of forming target groups, said specified purposes comprise suitability of candidates for managerial jobs and similarity of candidate goals in a target group.

9. The method as in claim 1, wherein said step of nurturing comprises offering candidates in a respective target group an opportunity for enhanced education/training, and exposure to new areas of expertise.

10. The method as in claiml, wherein for the step of forming target groups, said specified purposes include a selection from high potentials, alumni, and fresh graduates.

11. The method as in claim 1, including the step of tracking as to when a specific candidate becomes listed in a known target group.

12. The method as in claim 2, including the step of tracking a candidate's employment history in the organization.

13. The method as in claim 2, including the step of displaying target groups, purposes thereof and candidates therein, as well as a respective recruiter, on a UI (user interface) which is accessible to authorized personnel.

14. The method as in claim 13, wherein said recruiter is an administrator in the organization.

15. The method as in claim 13, wherein said recruiter is a staffing analyst.

16. The method as in claim 1, including the step of automatically interacting with candidates in a specific target group to obtain feedback and offer candidates certain tailored services based on the feedback, to implement effective talent relationship management.

17. The method as in claim 1 including the step of automatically searching the talent pool for suitable candidates for a specified target group and enlisting them into the specified target group.

18. The method as in claim 1, including the step of investigating if a specified candidate can fit into more than one target group, and if so, enlisting said specified candidate in more than one target group.

19. The method as in claim 17, including the step of automatically ensuring that a predetermined number of candidates is maintained in a specific target group, and the predetermined number is displayed in the UI.

20. The method as in claim 2, including the step of automatically selecting a suitable target group to refer to, when a vacancy in the organization arises.

21. A method of suggesting a suitable candidate to fill a vacancy in an organization, using a target candidate group from a talent pool of potential candidates, comprising the steps of:
using a UI (user interface) connected to a database and selectively to other information, to obtain notification of a position vacancy;
generating a requisition to fill the vacancy;
initiating a candidate search in a selected target candidate group;
completing an interaction among a UI user, a business partner/manager and a central coordinating person to obtain an output and feed to a relevant target group;
initiate an application from a chosen potential candidate to fill the vacancy; and,
authorize posting of the candidate to fill the vacancy.

22. An article comprising a storage medium having instructions thereon which when executed by a computing platform result in execution of a method of maintaining talent relationship with candidates from a talent pool, comprising the steps of:
consolidating a talent pool of candidates and obtaining candidate attributes from sources selectively including database/s and questionnaires sent to said candidates;
based on said candidate attributes, performing candidate classification using predetermined requirements;
from said candidate classification, forming, storing and maintaining target groups of candidates using specified purposes;
using said target groups to nurture/develop candidates' interest in selected target groups.

23. An article comprising a storage medium having instructions thereon which when executed by a computing platform result in execution of a method for automatically identifying a potentially suitable candidate from a talent pool to fill a vacancy in an organization, comprising the steps of:
consolidating a talent pool of candidates and obtaining candidate attributes from sources selectively including database/s and questionnaires sent to said candidates;
based on said candidate attributes, performing candidate classification using predetermined requirements;
from said candidate classification, forming, storing and maintaining target groups of candidates using specified purposes;
using a selected target group to identify possible candidates to fill a vacant position in the organization as desired.

24. An article comprising a storage medium having instructions thereon which when executed by a computing platform result in execution of a method for automatically suggesting a suitable candidate to fill a vacancy in an organization, using a target candidate group from a talent pool of potential candidates, comprising the steps of:
using a UI (user interface) connected to a database and selectively to other information, to obtain notification of a position vacancy;
generating a requisition to fill the vacancy;
initiating a candidate search in a selected target candidate group;
completing an interaction among a UI user, a business partner/manager and a central coordinating person to obtain an output and feed to a relevant target group to choose a suitable potential candidate;
initiate an application from the chosen potential candidate to fill the vacancy; and,
authorize posting of the candidate to fill the vacancy.
